(19) United States
(12) Patent Application Publication
(10) Pub. No.: US 2013/0148658 A1
(43) Pub. Date: Jun. 13, 2013

(54) SYSTEMS AND METHODS FOR SCALABLE MULTICAST COMMUNICATION USING SELF-ROOTED FORWARDING TREES

(71) Applicants: Bakul Grover Khanna, Lexington, MA (US); David P. Wiggins, Burlington, MA (US); Cesar A. Santivanez, Boston, MA (US); Subramanian Ramanathan, Westford, MA (US); William Nii Tetteh, Cambridge, MA (US)

(72) Inventors: Bakul Grover Khanna, Lexington, MA (US); David P. Wiggins, Burlington, MA (US); Cesar A. Santivanez, Boston, MA (US); Subramanian Ramanathan, Westford, MA (US); William Nii Tetteh, Cambridge, MA (US)

(73) Assignee: Raytheon BBN Technologies Corp, Cambridge, MA (US)

(21) Appl. No.: 13/315,469

(22) Filed: Dec. 9, 2011

(51) Int. Cl. H04L 12/56

(52) U.S. Cl. 370/390; 370/401

(57) ABSTRACT

Systems and methods are disclosed herein for multicasting a data packet through a wireless network. The method includes a packet metadata which maintains a set of next-hop nodes on the routing path as well as the assigned destination nodes of the packet. In addition, each node maintains only a single self-rooted forwarding tree for determining the routing path. By using the metadata in conjunction with a single forwarding tree at each node, the method introduces a highly scalable alternative to multicast protocols based on link state routing source-based trees while substantially reducing the processor load. Furthermore, the method does not require a consistent view of the network topology, making it useful in mobile scenarios. Also included is a mechanism to minimize the packet metadata size for minimal impact to performance while supporting arbitrarily large multicast group sizes.

### GOVERNMENT CONTRACT

The U.S. Government has a paid-up license in this invention and the right in limited circumstances to require the patent owner to license others on reasonable terms as provided for by the terms of Contract No. FA8750-07-C-0169, awarded by the Defense Advanced Research Project Agency (DARPA).

### FIELD OF THE INVENTION

The present invention generally relates to systems and methods for efficiently multicasting a data packet through a wireless network.

### BACKGROUND OF THE INVENTION

Multicast is a method of sending data packets over a network infrastructure to a group of interested group members in a single transmission. It uses network infrastructure efficiently by requiring the source to send a packet only once, even if it needs to be delivered to a large number of group members. The transit nodes, i.e. nodes lying between the source node and the destination nodes, replicate the packet to reach multiple group members such that the packets are sent over a network link only once. This is different from unicast where the source sends as many copies of the packet as there are intended recipients. Multicast is an essential service in military networks and the Internet and is widely deployed in wireless and wired networks. Its driving applications include voice, video, on-line gaming, and situational awareness.

Multicast can be implemented using proactive or reactive multicast routing protocols. Proactive routing has been seen to be more appropriate for military ad-hoc networks in battlefields. Most, if not all military systems under development (e.g. WNW, WNaN, SRW, etc.) utilize proactive routing. Proactive routing is also commonly used in the Internet. Link state routing source-based trees multicast routing protocols, using Shortest Path Forwarding (SPF) trees, are often used to direct multicast traffic through the network. A SPF tree provides the shortest path between a source and destination node, ensuring the minimum amount of network latency for multicast traffic. Other common forwarding trees include multi-point relaying (MPR) trees, which a node can generally calculate with lower processor overhead compared to SPF trees, and Steiner trees, which attempt to minimize the number of transmissions from source to destination.

However, existing multicast routing protocols based on simple link state routing source-based trees exhibit two major problems which prevent them from being scaled to networks with a large number of nodes. First, in order to avoid redundant transmissions and transmission loops, these protocols involve each node computing an SPF tree for all other nodes in the network. This is computationally expensive and makes these protocols difficult to scale for a large number of nodes in the network. Second, these existing protocols require a consistent network topology view, which is not realistic in mobile scenarios.

### SUMMARY OF THE INVENTION

The systems and methods described herein provide an efficient alternative to link state routing source-based trees for multicasting a data packet through a wireless network. In contrast to the existing multicast protocols described above, each node maintains only a self-rooted forwarding tree (i.e. a tree in which each node maintains a single forwarding tree where that node is the root of the forwarding tree) for determining the routing path. Using a self-rooted forwarding tree as the sole forwarding multicast mechanism results in redundant multicast packet transmissions in the network. To solve the problem of redundant packets, packet metadata is introduced which maintains information regarding the next-hop node on the routing path as well as the corresponding destination node to which each next-hop node is responsible for forwarding the packet. This ensures that only intended transit nodes on the desired routing path will forward the packet.

To multicast a data packet, the source node first identifies the desired destination nodes of the packet using existing multicast addressing resolution techniques known in the art. In one embodiment of the invention, a SPF tree is used to resolve the routing path for the data packet from source to destination. For each destination node, the source node uses the SPF tree to determine a next-hop node, which represents the next step on the routing path to the destination node. The source node then generates packet metadata including the list of next-hop and corresponding destination nodes and appends it to the beginning of the data packet. The data packet, which now includes the metadata, is then broadcast over the network.

The method for retransmitting a data packet at a transit node is slightly different from the method for transmitting from a source node. Upon receiving the data packet, the transit node first checks the metadata to determine whether it is included in the list of next-hop nodes. If it is not, then the packet is dropped, ensuring that the packet is forwarded by only the intended recipients. If the transit node identifies itself as a next-hop node based on the metadata, the transit node identifies from the metadata the multicast group members to which it is responsible for forwarding the packet, hereinafter referred to as its assigned destination nodes. The transit node then performs a SPF tree lookup to resolve the routing path from itself to each assigned destination node. The new path is used to determine a new next-hop node, and the process is repeated for each assigned destination node. The transit node updates the metadata with the new set of next-hop nodes and assigned destination nodes, and the data packet is broadcast to the network. This method ensures that only a reduced number of copies of the data packet, in some cases only one copy, are forwarded to each destination node, which reduces the number of redundant data packets on the network.

In some embodiments, the metadata may be processed to reduce its size such that there is a minimal increase in the packet size due to the metadata. For example, 8-bit aliases can be assigned instead of the full 32-bit node IDs to each of the nodes within a 1-hop neighborhood. Since the number of 1-hop neighbors is usually limited due to MAC scaling issues, the use of 8-bit aliases does not generally result in a loss in functionality. These aliases can be added to heartbeat messages already known in the art for nodes in wireless networks to determine neighbor reachability. By using aliases, the next-hop node may be addressed by a single bit in a bitmap and the size of the metadata can be substantially reduced while still maintaining the functionality of node IDs. In some embodiments, the alias can be 4-bits, 12-bits, or any suitable size to reduce the size of the metadata while maintaining functionality. For larger multicast groups, to avoid having the metadata grow too large, the source node divides the multicast group member list into multiple virtual multicast groups and sends a copy of the packet to each virtual group.

In some embodiments, alternative forwarding trees to SPF trees may be used with the packet metadata. Specifically, a node can generally calculate MPR trees with lower processing overhead than SPF trees, making MPR trees ideal for applications with limited processing resources. Steiner trees attempt to minimize the number of transmissions from source to destination. Depending on the requirements of the specific application, these alternatives may be desirable over SPF trees due to their respective benefits.

In some embodiments such as mobile scenarios, the routing path to the destination may have changed due to changes in the network topology. For example, new nodes may have been introduced or removed from the network or environmental conditions may degrade the link to certain nodes. Upon the detection of a network topology change, the forwarding tree at each node may be updated using any suitable method. This ensures that the packet follows the optimal routing path to its destination as defined by the most up-to-date forwarding tree, even if a network topology change causes the optimal path to change during transfer. Each node does not require a consistent view of the network topology.

In some embodiments, duplicate detection can be used to eliminate redundant packets. Furthermore, the method can be modified for controlled redundancy, allowing the source to send multiple copies to different next-hop nodes with the intention of increasing the probability of delivery. In such an application, the duplicate detection may need to be modified to allow a certain number of redundant packets through the system.

### BRIEF DESCRIPTION OF THE FIGURES

The following figures depict certain illustrative embodiments of the invention in which like reference numerals refer to like elements. These depicted embodiments may not be drawn to scale and are to be understood as illustrative of the invention and not as limiting in any way.

FIG. 1 is a block diagram of a node according to an illustrative embodiment of the invention.

FIG. 2 is a network of several of the nodes from FIG. 1 arranged in a network according to an illustrative embodiment of the invention.

FIG. 3 is a flowchart which describes the steps taken by a source node to multicast a data packet through the network of FIG. 2 to a plurality of destination nodes according to an illustrative embodiment of the invention.

FIG. 4 is an example of data packet metadata used by the nodes of FIG. 2 that includes the next-hop and assigned destination nodes of the data packet according to an illustrative embodiment of the invention.

FIG. 5 is a flowchart which describes the steps taken by a transit node to receive and retransmit a data packet through the network of FIG. 2 to the assigned destination nodes according to an illustrative embodiment of the invention.

FIG. 6 is a network view of several nodes in a wireless network including the data packet metadata from FIG. 4 for each broadcast step according to an illustrative embodiment of the invention.

### DETAILED DESCRIPTION OF THE FIGURES

To provide an overall understanding of the invention, certain illustrative embodiments will now be described, including methods for multicasting data packets through a wireless network. However, it will be understood by one of ordinary skill in the art that the methods and systems described herein may be adapted and modified as is appropriate for the application being addressed and that the system and methods described herein may be employed in other suitable applications, and that such other additions and modifications will not depart from the scope hereof.

As will be seen from the following description, in one embodiment, the invention relates to systems and methods for multicasting a data packet through a wireless network. In contrast to existing multicast protocols, in one embodiment, each node maintains only a self-rooted forwarding tree (i.e. a tree in which each node maintains a single forwarding tree where that node is the root of the forwarding tree) for determining the routing path. Furthermore, packet metadata is introduced which identifies the next-hop node on the routing path as well as assigned destination nodes to which the next-hop node is responsible for delivering the data packet.

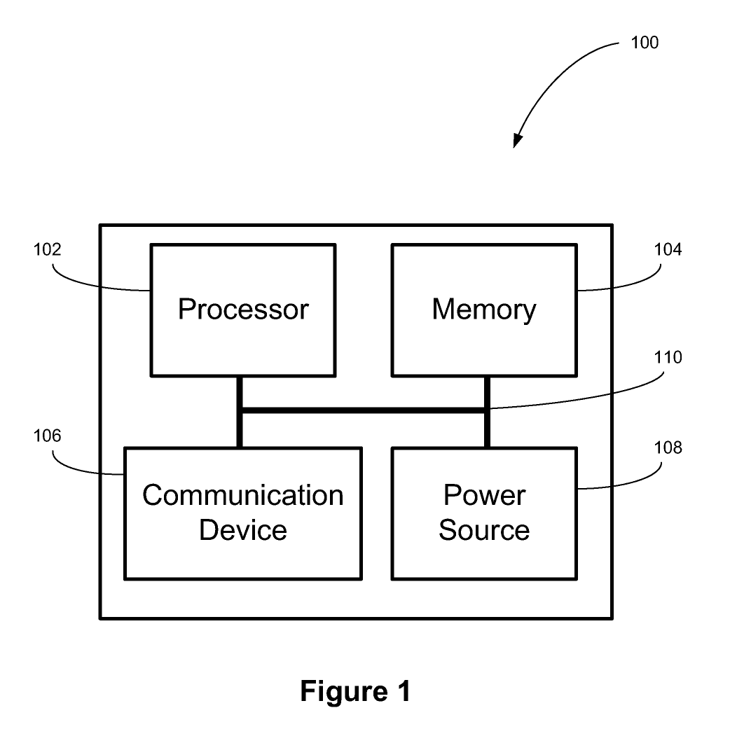

FIG. 1 is a block diagram of a node for multicasting packets through a network according to an illustrative embodiment of the invention. The major components of the node 100 include a processor 102, a memory 104, a communication device 106, a power source 108, and a bus 110. The communications device 106 receives and transmits the multicast packets and could take the form of a wireless transmitter, network interface card, network switch, network bridge, or any other suitable device for forwarding data packets through a network. The processor 102 could take the form of a general purpose processor, a microprocessor such as an application-specific integrated circuit (ASIC), a plurality of microprocessors, a field programmable gate array (FPGA), an embedded processor such as the ARM processor, or any other suitable processor for use in a computing system. The memory 104 could take the form of volatile memory such as DRAM or SRAM, non-volatile memory such as flash memory, a magnetic disk, an optical disk, or any other suitable device for storing information in a computing system. The power source 108 could include a battery for mobile nodes or a standard wired AC adapter for fixed nodes. The bus 110 connects the memory 104, the communications device 106, and the processor 102.

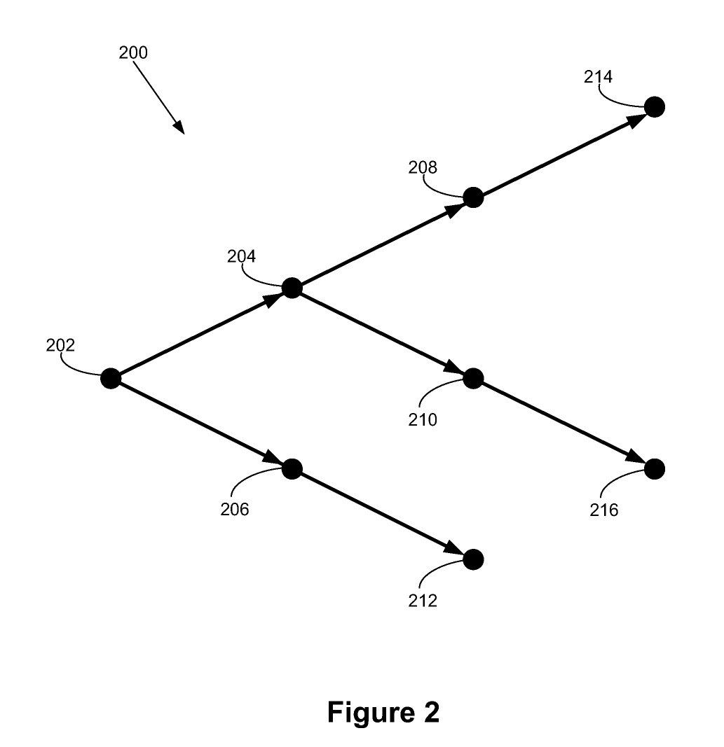

FIG. 2 shows a network 200 of several of the nodes 100 from FIG. 1 according to an illustrative embodiment of the invention. Note that although the network 200 hereinafter will be described as a wireless network, the invention could be used for a wired network or a network with a combination of wired and wireless links. The network 200 shows a plurality of nodes 202 through 216 including links to show the network topology. Note that the topology is logical in nature and does not necessarily correspond to the physical topology of the network. That is, while node 202, which serves as the source node in the following discussion, appears on an edge of the network, it may actually be located anywhere in the network including at the edge, in the geographic center, or anywhere in between. Similarly, any of the other nodes 204-216 could serve as the source node. In such cases, the logical network topology may look very different, even though the network conditions would not have changed. The directions of the links represent a forwarding tree from the perspective of the source node 202. In one embodiment, the forwarding tree is a SPF tree, which describes the shortest path from the source node 202 to each of the other nodes in the network. In other embodiments, alternative routing schemes can be used depending on the requirements of the application. For example, a node can generally calculate MPR trees with lower processor overhead compared to calculating SPF trees. Steiner trees, which attempt to minimize the number of transmissions from source to destination, may be another alternative to SPF trees for determining the routing path. Depending on the requirements of the application, other alternatives could be desirable. In one embodiment of the invention, each node only maintains a self-rooted forwarding tree and does not calculate forwarding trees for other nodes in the multicast group. The forwarding tree can be stored as a single tree or subdivided as desired into multiple trees, all having the self-rooted node as the root of the tree.

In some embodiments, the network topology can vary with time. For networks that include mobile nodes, when new nodes are introduced into or leave the network, or when environmental conditions disrupt links between nodes, each node 202-216 recalculates its self-rooted forwarding tree, thereby maintaining the forwarding tree even in unstable network topologies.

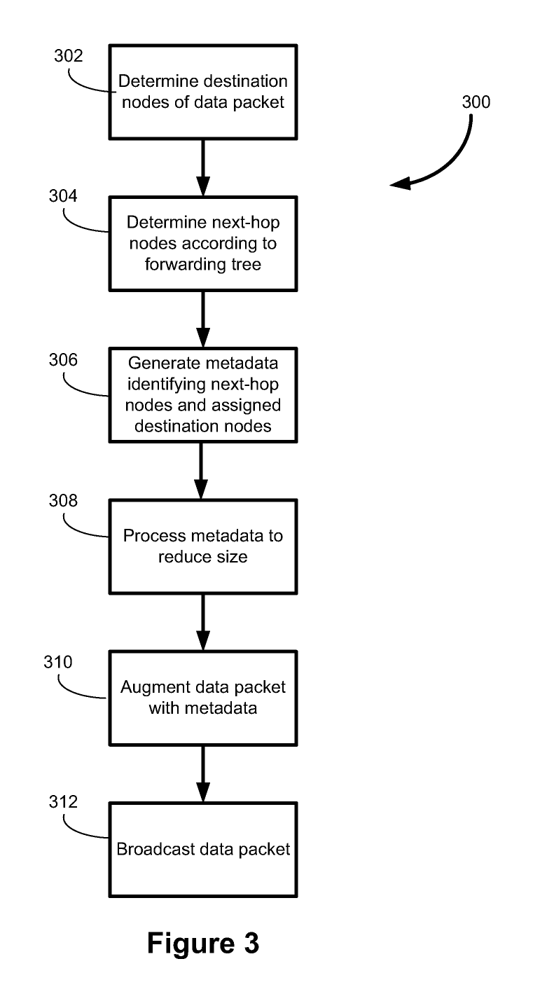

FIG. 3 depicts the method 300 by which a packet is multicast from a source node, such as a source node 202, according to one embodiment of the present invention. The method includes the steps of determining the desired destination nodes of a data packet (step 302), determining a corresponding next-hop node that is responsible for delivering the data packet to each destination node (step 304), generating metadata identifying the next-hop nodes and assigned destination nodes (step 306), processing the metadata to reduce its size (step 308), augmenting the data packet with the metadata (step 310), and broadcasting the data packet (step 312).

As set forth above, the source node 202 first determines the destination nodes of the data packet (step 302). The packet is addressed to a multicast group. To determine the destination nodes of the packet, the source node 202 uses standard multicast address resolution techniques known in the art.

For each destination node, the source node 202 determines a corresponding next-hop node using its maintained forwarding tree (step 304). In one embodiment, the forwarding tree is a SPF tree, which is used to resolve the routing path from source to destination. The source node 202 then generates packet metadata including the list of next-hop nodes and assigned destination nodes (step 306).

The source node 202 may optionally reduce the size of the metadata (step 308) prior to augmenting the data packet with the metadata (step 310). Specifically, the source node 202 may assign unique 8-bit aliases instead of full 32-bit node IDs to the nodes in its 1-hop neighborhood. Neighbors may exchange aliases by adding them to periodic heartbeat packets known in the art for wireless networks or by using other regular communications. By using these aliases, each node can still interpret the next-hop node lists based on their maintained list of aliases, and the size of the metadata may be reduced while still maintaining its functionality. In one embodiment, the alias for a next-hop node can be assigned a position in a bitmap and addressed by a single bit in a bitmap. Since the number of 1-hop neighbors is usually limited due to MAC scaling issues, the use of 8-bit aliases does not generally result in a loss in functionality. In some embodiments, the alias can be 4-bits, 12-bits, or any suitable size to reduce the size of the metadata while maintaining functionality. For larger multicast groups, to avoid having the metadata grow too large, the source node divides the multicast group member list into multiple virtual multicast groups and sends a copy of the packet to each virtual group.

After reducing the size of the metadata as indicated above, the source node 202 appends it to the beginning of the data packet (step 310). The data packet, which now includes the processed metadata, is then broadcast over the network (step 312).

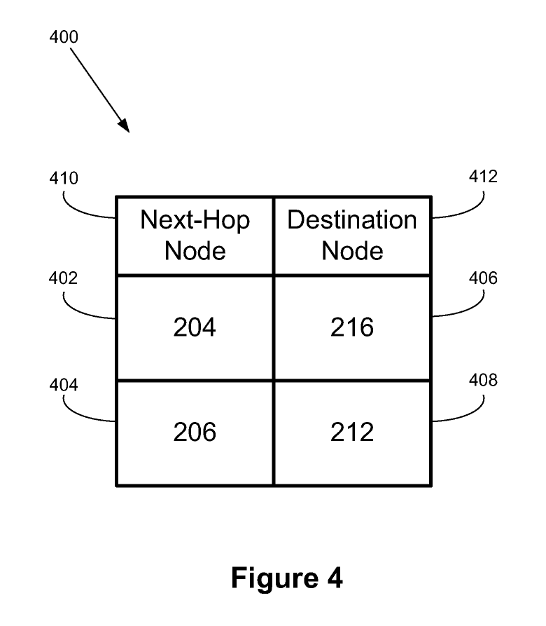

FIG. 4 shows an illustrative example of packet metadata 400 used in the method 300 depicted in FIG. 3. Although the metadata 400 is shown in tabular format for ease of explanation, the metadata 400 may also take the form of an ordered list, array, or any other suitable data structure to minimize its size. The metadata 400 includes a list of next-hop nodes 410 as well as a list of assigned destination nodes 412 to which the next-hop nodes are responsible for delivering the packet. The entries 402 and 404 may be the 8-bit aliases described above to reduce the size of the metadata. By reviewing the list of next-hop nodes 410 in the metadata 400, transit nodes can determine whether they are an intended intermediate recipient on the SPF tree from source to destination without having to calculate additional per-source SPF trees. This reduces the computational load on each node as well as the number of redundant messages broadcast on the network, thereby improving bandwidth, network load, and the packet delivery ratio. Even though the processing of the metadata results in a slight resource cost, the cost is greatly outweighed by the processor cycles saved by maintaining only a single SPF tree per node.

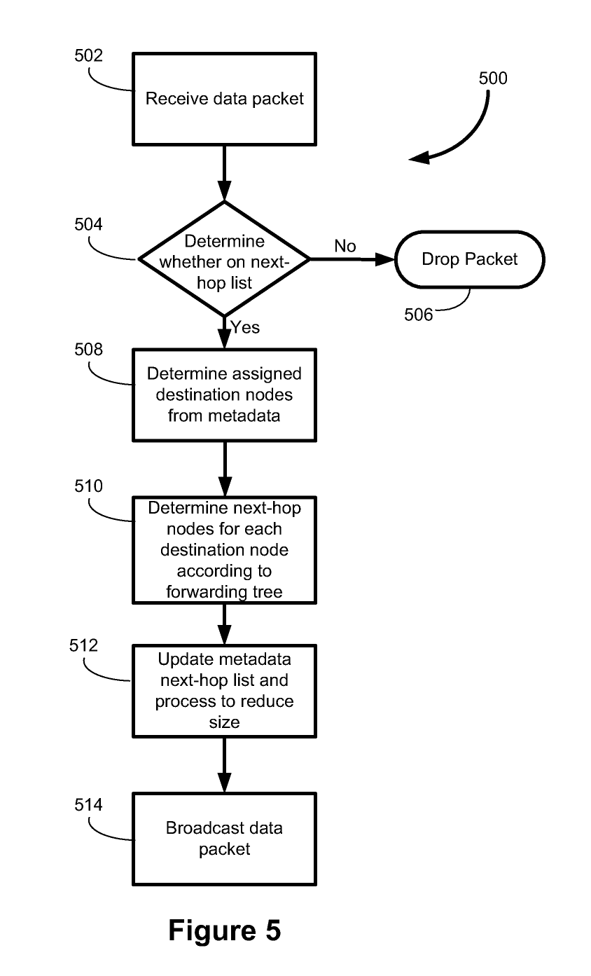

FIG. 5 depicts the method 500 for receiving and retransmitting a multicast packet by a transit node. Upon receiving the data packet (step 502), the transit node first checks the metadata to determine whether the node is included in the next-hop list (decision 504). If the transit node is not on the next-hop list, it will drop the packet (step 506). This mechanism ensures that only intended recipients forward the data packet and keeps only a reduced number of copies, in some embodiments only one copy, of a data packet flowing through the network for each destination node. If the transit node is included in the next hop list, it will proceed to determine the assigned destination nodes to which it is responsible for delivering the packet (step 508). In contrast to the analogous step for the source node 202 described above (step 302), the transit node determines the assigned destination nodes by extracting them from the metadata instead of resolving the multicast group directly.

For the set of assigned destination nodes, the transit node determines the corresponding next-hop nodes using its maintained forwarding tree (step 510), which is similar to the analogous step for the source node 202 described above (step 304). In some embodiments, such as mobile applications, the optimal path may change due to changes in the network topology, which is reflected in the maintained forwarding tree at each transit node. Each node makes packet forwarding decisions based on its self-rooted forwarding tree, which results in the packet always being forwarded according to the up to date routing path. The transit node then updates the next-hop list in the existing metadata, which may include processing the metadata to reduce its size and replacing the existing metadata (step 512), and broadcasts the packet to the network (step 514).

In some embodiments of the invention, duplicate detection can be used to eliminate redundant packets. The duplicate detection can also be configured to allow for controlled redundancy, allowing a predetermined number of duplicate packets through to increase the probability of packet delivery. For example, the source node 202 might initially or probabilistically send multiple copies of the same data packet to different next-hop nodes with the intention of increasing the probability of delivery.

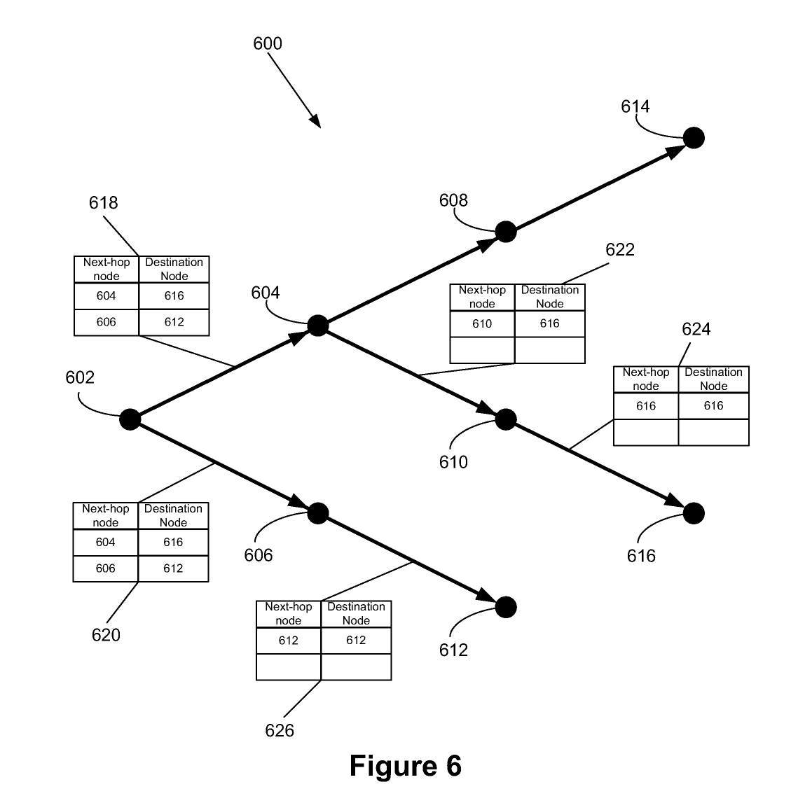

FIG. 6 shows the network 200 of FIG. 2 as well as the packet metadata 618 through 624 that would be included for each broadcast step as a packet traverses the network. In this illustrative example, the source node 602 identifies the destination nodes 616 and 612 (step 302) as the members of the target multicast group and determines the next-hop nodes 604 and 606 using its maintained forwarding tree (step 304). The metadata 618 is generated with the list of next-hop and assigned destination nodes (step 306) and is appended to the data packet (step 310). The packet is broadcast once by the source node 602 (step 312), intended for the desired transit nodes 604 and 606.

Although other nodes in the area may receive the data packet, only the desired transit nodes 604 and 606 will identify themselves as on the next-hop node list and correctly forward the packet (step 504). Transit nodes 604 and 606 update the next-hop node list in the packet metadata for their assigned destination nodes 616 and 612 (steps 508, 510, and 512). The nodes 604 and 606 broadcast the packet again for the next set of intended next-hop nodes. The process is repeated until the data packet reaches its intended destination node 616 or 612.

By using the packet metadata in conjunction with a self-rooted forwarding tree at each node, a data packet can be multicast on the optimal path from source to destination without any redundant transmissions. The elimination of multiple SPF tree calculations at each transit node significantly reduces the processing load, which also makes this method highly scalable for large networks.

It will be apparent to those skilled in the art that such embodiments are provided by way of example only. It should be understood that numerous variation, alternatives, changes, and substitutions may be employed by those skilled in the art in practicing the invention. It is intended that the following claims define the scope of the invention and the methods and structures within the scope of these claims and their equivalents be covered thereby.

What is claimed is:

1. A method for multicasting a data packet through a network including a plurality of wireless links between nodes, comprising:
maintaining at a first node a self-rooted forwarding tree which indicates the routing path from the first node to each node in the network;
identifying, at the first node, members of a multicast group to which the data packet is targeted;
determining, using the maintained self-rooted forwarding tree at the first node, metadata including a set of next-hop nodes to receive the data packet and a subset of the multicast group members to which each of such next-hop nodes is responsible for forwarding the data packet;
processing the metadata at the first node to reduce a number of bits necessary to convey the metadata over the network;
augmenting the data packet with the processed metadata at the first node; and
broadcasting, at the first node, the augmented data packet over the network.

2. The method of claim 1 wherein the first node is the original source of the data packet.

3. The method of claim 1 wherein the network further includes a plurality of wired links.

4. The method of claim 1, comprising receiving the data packet at the first node prior to the first node determining the metadata, wherein identifying members of a multicast group to which the data packet is targeted comprises
processing the metadata included in the received packet to identify members of the multicast group to which the first node is responsible for forwarding the data packet; and
identifying a next-hop node associated with each identified member of the multicast group.

5. The method of claim 4, wherein augmenting the data packet comprises replacing the metadata in the received data packet with the processed metadata generated by the first node.

6. The method of claim 4, further comprising
receiving a second data packet at the first node;
processing the metadata of the second data packet to determine whether the first node is included in the set of next-hop nodes; and
dropping the second data packet if the first node is not included in the set of next-hop nodes.

7. The method of claim 1, wherein identifying members of a multicast group to which the data packet is targeted comprises resolving the multicast group.

8. The method of claim 1 wherein identifying members of a multicast group to which the data packet is targeted comprises identifying fewer than a predetermined number of members.

9. The method of claim 1, wherein maintaining the self-rooted forwarding tree comprises updating the self-rooted forwarding tree in response to detecting a change in network topology.

10. The method of claim 1, comprising assigning by the first node an alias which is shorter than an original node ID associated with a given next-hop node, and wherein processing the metadata comprises replacing the original node IDs associated with the next-hop nodes with the corresponding assigned aliases.

11. The method of claim 1 wherein the first node detects whether a duplicate packet as a previous packet has already been transmitted.

12. The method of claim 1 wherein the first node transmits an intentional redundant data packet as a previous packet to different next-hop nodes.

13. The method of claim 1 wherein the self-rooted forwarding tree is one of the following: a Shortest Path Forwarding (SPF) tree, a multi-point relaying (MPR) tree, or a Steiner tree.

14. A device for forwarding data throughout a network including a plurality of wireless links between nodes, the device comprising:
a communications device for receiving and transmitting data packets;
a memory for storing information including a self-rooted forwarding tree, a list of multicast group memberships; and
a processor configured to:
maintain a self-rooted forwarding tree which indicates a routing path from a first node to a plurality of nodes in the network;
determine, using the maintained forwarding tree, metadata including a set of next-hop nodes to receive a data packet and a subset of multicast group members to which each of such next-hop nodes is responsible for forwarding the data packet;
process the determined metadata to reduce a number of bits necessary to convey the metadata over a network;
augment the data packet with the processed metadata; and
broadcast the augmented data packet over a network.

15. The device of claim 14, wherein the network further includes a plurality of wired links.

16. The device of claim 14, wherein augmenting the data packet comprises replacing the metadata from the data packet with the processed metadata.

17. The device of claim 14, wherein the processor is further configured to determine based on the metadata of a second data packet whether the node is included in a set of next-hop nodes and drop the second data packet if the node is not included in the set of next-hop nodes.

18. The device of claim 14, wherein identifying members of a multicast group to which the data packet is targeted comprises resolving the multicast group.

19. The device of claim 14, wherein identifying members of a multicast group to which the data packet is targeted comprises identifying fewer than a predetermined number of members.

20. The device of claim 14, wherein maintaining the self-rooted forwarding tree comprises updating the self-rooted forwarding tree in response to detecting a change in network topology.

21. The device of claim 14, wherein the processor is further configured to assign an alias which is shorter than an original node ID associated with a given next-hop node to the next-hop node, and wherein processing the metadata comprises replacing the original node ID associated with the next-hop node with the corresponding assigned alias.

22. The device of claim 14, wherein the processor is further configured to detect whether a duplicate packet as a previous packet has already been transmitted.

23. The device of claim 14, wherein the processor is further configured to transmit an intentional redundant data packet as a previous packet to different next-hop nodes.

24. The device of claim 14, wherein the self-rooted forwarding tree is one of the following: a Shortest Path Forwarding (SPF) tree, a multi-point relaying (MPR) tree, or a Steiner tree.
